(19) United States
(12) Patent Application Publication
(10) Pub. No.: US 2020/0290526 A1
(43) Pub. Date: Sep. 17, 2020

(54) FOLDING INTERIOR LINING PANEL FOR A MOTOR VEHICLE

(71) Applicants: TREVES PRODUCTS, SERVICES & INNOVATION, Paris (FR); HONDA MOTOR Co LTD, Tokyo (JP)

(72) Inventors: Christophe BLOM, Reims (FR); Gini PSYMOULI, Swindon Wiltshire (GB); Tohru OHBA, Swindon Wiltshire (GB)

(21) Appl. No.: 16/491,857

(22) PCT Filed: Mar. 9, 2018
(86) PCT No.: PCT/FR2018/050561

§ 371 Date: Sep. 6, 2019

(30) Foreign Application Priority Data
Mar. 9, 2017 (FR) 1751935

(51) Int. Cl. B60R 13/02

(52) U.S. Cl. CPC B60R 13/0275; B60R 5/045; B60R 13/0268

(57) ABSTRACT

The invention relates to a folding interior lining panel for a motor vehicle comprising a first articulated flap and a second articulated flap, having a first front face and a second front face and a first back face and a second back face. The front faces are covered with a first front covering layer and a second front covering layer. The articulation between the flaps is provided by two first strips spaced apart from each other, the strips being integral with the first layer, the strips having a free end portion attached to the second back face. At least one second strip is arranged between the first strips, the strip being integral with the second layer and having a free end portion attached to the first back face.

### CROSS-REFERENCE TO RELATED APPLICATIONS

This application claims the benefit of International application number PCT/FR2018/050561, filed Mar. 9, 2018 and French application number 1751935, filed Mar. 9, 2017 the entire contents of which are incorporated herein by reference.

### TECHNICAL FIELD

The invention relates to a folding interior lining panel for a motor vehicle.

### BACKGROUND

Producing a folding interior lining panel for a motor vehicle is known, the panel having the following features:
it comprises first and second flaps articulated on each other on two respective articulation edges, so as to allow rotation of substantially 360° of one of the flaps with respect to the other, so that the panel can have a use configuration where the flaps are in line with one another in a substantially coplanar fashion, and two retracted configurations corresponding to a folding through 180° in one direction or the other,
the sides of the flaps at the edges is of similar thickness,
the flaps have respectively a first and second front face and a first and second back face, the front faces being respectively covered with a first and second front covering layer.

The folding panel is in particular intended to cover the luggage or the floor of a luggage compartment.

Having available two retracted configurations is for example dictated, in the case of a panel covering a luggage compartment floor, by the fact that one face of the flaps may be covered with textile, for example in the form of carpet, the other face being covered with a washable covering, in particular of the nature of a sheet of plastics material.

Thus, when the folding panel is in the retracted configuration, it may be disposed against a wall of the luggage compartment while having a washable face, which may prove to be useful when the compartment is loaded with a dirty load.

Various arrangements have been proposed, in particular based on the use of attached flexible strips.

However, the known arrangements are often complex to implement and therefore expensive, mainly because of the many operations to be performed for fixing the strips.

### SUMMARY OF THE INVENTION

The aim of the invention is to overcome this drawback.

To this end, the invention proposes a folding interior lining panel for a motor vehicle, the panel having the following features:
it comprises first and second flaps articulated on each other on two respective articulation edges, so as to allow rotation of substantially 360° of one of the flaps with respect to the other, so that the panel can have a use configuration where the flaps are in line with one another in a substantially coplanar fashion, and two retracted configurations corresponding to a folding through 180° in one direction or the other,
the sides of the flaps at the edges is of similar thickness,
the flaps have respectively a first and second front face and a first and second back face, the front faces being respectively covered with a first and second front covering layer,

the articulation between the flaps being formed by:
at least two first strips spaced apart from each other, the strips being integral with the first layer, the strips having a free end portion attached to the second back face so as to leave clear a middle portion, the dimension of which in a direction perpendicular to the edges corresponds substantially to the thickness,
and at least one second strip arranged between the first strips, the strip being integral with the second layer, the strip having a free end portion attached to the first back face so as to leave clear a middle portion, the dimension of which in a direction perpendicular to the edges corresponds substantially to the thickness.

With the arrangement proposed, the strips are integral with the front covering layers, which avoids having to attach them to the flaps with which they are integral.

Thus the only operation for attaching the strips to be carried out is the one corresponding to the attaching of the free end portions of the strips.

In this way, the manufacture of the panel is simplified and the cost thereof is reduced.

### BRIEF DESCRIPTION OF THE DRAWINGS

Other particularities and advantages of the invention will emerge from the following description given with reference to the accompanying figures, in which:

FIGS. 1a and 1b are schematic perspective views of a panel according to the invention, the panel being in the use configuration (FIG. 1a) and the retracted configuration (FIG. 1b),

FIGS. 2a and 2b are lateral and cross-sectional schematic views of the panel in FIG. 1 according to a first embodiment, the flaps being in the use configuration (FIG. 2a) and the retracted configuration (FIG. 2b),

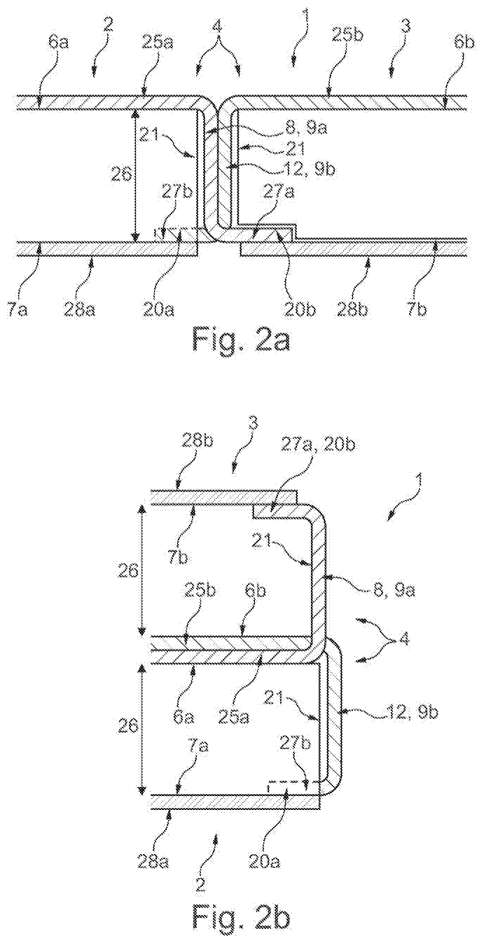

FIG. 3 is a view similar to FIG. 2a for a panel according to a second embodiment.

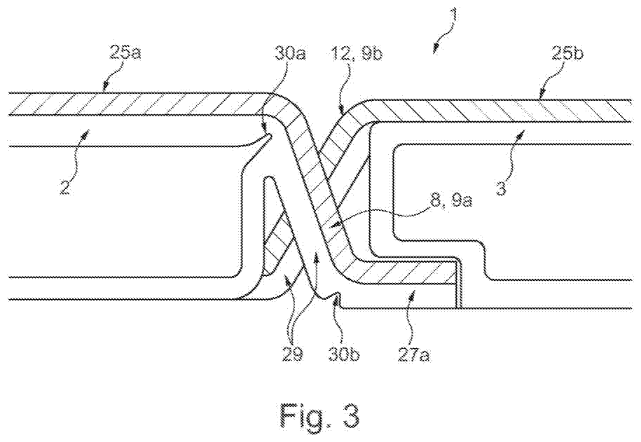

### DETAILED DESCRIPTION

With reference to the figures, a description is given of a folding interior lining panel 1 for a motor vehicle, the panel having the following features:
it comprises first 2 and second 3 flaps articulated on each other on two respective articulation edges 4, so as to allow rotation of substantially 360° of one of the flaps with respect to the other, so that the panel can have a use configuration where the flaps are in line with one another in a substantially coplanar fashion, and two retracted configurations corresponding to a folding through 180° in one direction or the other,
the sides 21 of the flaps at the edges have a similar thickness 26,
the flaps have respectively a first 6a and second 6b front face and a first 7a and second 7b back face, the front faces being respectively covered with a first 25a and second 25b front covering layer, for example made of carpet or nonwoven material,
   the articulation between the flaps being formed by:
at least two first strips 8 spaced apart from each other, the strips being integral with the first layer, the strips having a free end portion 27a attached to the second back face so as to leave clear a middle portion 9a, the dimension of which in a direction perpendicular to the edges corresponds substantially to the thickness,
and at least one second strip 12 arranged between the first strips, the strip being integral with the second layer, the strip having a free end portion 27b attached to the first back face so as to leave clear a middle portion 9b, the dimension of which in a direction perpendicular to the edges corresponds substantially to the thickness.

The flaps may be based on various materials, for example based on polyurethane, injected plastics material, with a honeycomb structure, extruded and blow-moulded plastics material, etc.

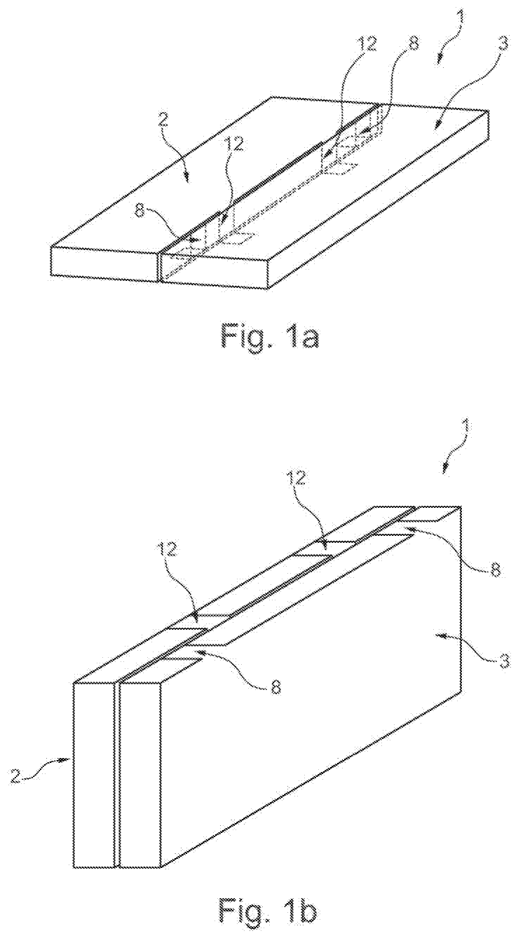

According to the embodiment depicted in FIG. 1, two first strips 8 are disposed substantially at the lateral ends of the edges 4.

According to one embodiment, the end portions 27a, 27b of the strips 8, 12 are attached by adhesive bonding.

Naturally, any other attaching method may be provided—such as stapling, screwing, etc—knowing that it is possible to combine a plurality of methods with each other.

According to the embodiments depicted, the first 2 and second 3 flaps are respectively covered on their back faces 7a, 7b with a first 28a and second 28b back covering layer, for example based on a sheet of plastics material, nonwoven material, or textile coated with plastics material, the end portions 27a, 27b of the strips 8, 12 being inserted between the back face 7b, 7a and the back covering layer 28b, 28a of the corresponding flap 3, 2.

According to the embodiments depicted, the flaps 2, 3 are provided with housings 20a, 20b for receiving the end portions 27b, 27a of the strips 12, 8, so that the end portions do not form a projection with respect to the back faces 7a, 7b of the corresponding flaps 2, 3.

According to an embodiment that is not shown, at least one strip 8, 12 is reinforced on its back with a reinforcing layer in order to improve the tensile strength thereof.

According to one embodiment, the reinforcing layer extends along the strip 8, 12 while encroaching in particular on the front face 6a, 6b of the flap 2, 3 with which the strip is integral, so as to provide reinforcement all along the strip.

The reinforcing layer is associated for example by adhesive bonding to the strip 8, 12.

The reinforcing layer is for example based on fabric used for manufacturing airbags, so as to have high tensile strength.

According to the second embodiment depicted, the flaps 2, 3 are produced by extrusion-blow moulding, the back of the strips 8, 12 being secured to a respective sheet 29 of plastics material integral with the flaps, the sheet being connected to the flap 2, 3 with which it is integral by means of a first zone of thinned material 30a so as to form a flexible hinge, the sheet having a second zone of thinned material 30b situated at the interface between the middle portion 9a, 9b and the end portion 27a, 27b of the strips.

In this case, provision can be made for fixing the free ends 27a, 27b of the strips 8, 12 in the same way as in the first embodiment, knowing that it is also possible to envisage attachment by welding.

In variants, not shown, applicable to all embodiments, it is possible to provide more than two first strips 8 and also more than a single second strip 12, as it is the case in the embodiment in FIG. 1, which provides two second strips 12.

In all embodiments, the strips 8, 12 may at leisure be staggered in alternation and/or in series.

In all the embodiments, in a way that is not shown, it is possible to provide for the front covering layers 25a, 25b of the flaps 2, 3 to cover, outside the zones of the strips 8, 12, the edges 21 of the flaps, and also folded over on a peripheral zone of the back faces 7a, 7b of the flaps, so as to provide an optimum peripheral finish.

1. A folding interior lining panel for a motor vehicle, the panel comprising:
first and second flaps articulated on each other on two respective articulation edges, to allow rotation of substantially 360° of one of the flaps with respect to the other, and the panel being configured where the flaps are in line with one another in a substantially coplanar fashion, and two retracted configurations corresponding to a folding through 180° in one direction or the other,
the sides of the flaps at the edges have a similar thickness,
the flaps have respectively a first and second front face and a first and second back face, the front faces being respectively covered with a first and second front covering layer,
the panel wherein the articulation between the flaps is formed by:
at least two first strips spaced apart from each other, the strips being integral with the first layer, the strips having a free end portion attached to the second back face to leave clear a middle portion, the dimension of which in a direction perpendicular to the edges corresponds substantially to the thickness,
and at least one second strip arranged between the first strips, the strip being integral with the second layer, the strip having a free end portion attached to the first back face to leave clear a middle portion, the dimension of which in a direction perpendicular to the edges corresponds substantially to the thickness.

2. A panel according to claim 1, wherein two first strips are disposed substantially at the lateral ends of the edges.

3. A panel according to claim 1, wherein the first and second flaps are respectively covered on their back faces with a first and second back covering layer, the end portions of the strips being inserted between the back face and the back covering layer of the corresponding flap.

4. A panel according to claim 1, wherein the flaps are provided with housings for receiving the end portions of the strips, the end portions do not form a projection with respect to the back faces of the corresponding flaps.

5. A panel according to claim 1, wherein the flaps are produced by extrusion-blow moulding, the back of the strips being secured to a respective sheet of plastics material integral with the flaps, the sheet being connected to the flap with which it is integral by a first zone of thinned material to form a flexible hinge, the sheet having a second zone of thinned material situated at the interface between the middle portion and the end portion of the strips.
